(19) United States
(12) Patent Application Publication
(10) Pub. No.: US 2008/0024749 A1
(43) Pub. Date: Jan. 31, 2008

(54) Low mass six degree of freedom stage for lithography tools

(75) Inventors: Mark Williams, Amherst, NH (US); Alton Phillips, East Palo Alto, CA (US)

Correspondence Address: KLARQUIST SPARKMAN, LLP, 121 SW SALMON STREET, SUITE 1600, PORTLAND, OR, 97204, US

(73) Assignee: Nikon Corporation, Tokyo (JP)

(21) Appl. No.: 11/804,734

(22) Filed: May 18, 2007

Related U.S. Application Data
(60) Provisional application No. 60/801,582, filed on May 18, 2006.

(51) Int. Cl. G03B 27/58; G03B 27/62; H02K 41/00

(52) U.S. Cl. 355/72; 310/12; 355/75

(57) ABSTRACT

A reticle or wafer stage mover with six degrees of freedom, a low mass coarse stage, and the ability to move an object in a scanning direction in a lithography tool. The mover includes a coarse stage and a fine stage configured to support the object and supported by the coarse stage. A set of actuators is provided to move the fine stage in six degrees of freedom. All of the actuators contribute to accelerating the object and the fine stage in the scanning direction. With all the actuators generating the necessary force to move the fine stage, a single large actuator to push the fine stage in the scanning direction is eliminated. The size or mass of the coarse stage is therefore reduced. All of the actuators are also capable of generating a second force in either the X or Z directions. The actuators therefore also enable the fine stage and the object it supports to be positioned in six degrees of freedom, as well as moved in the scanning direction.

### RELATED APPLICATIONS

This application claims priority on Provisional Application Ser. No. 60/801,582 filed on May 18, 2006 and entitled “Maglev Reticle Stage: Fine+Coarse/Carrier Stage”, the content of which is incorporated herein by reference for all purposes.

### BACKGROUND

1. Field of the Invention

The present invention relates to lithography, and more particularly, to a stage design including a low mass coarse stage that provides support and positions a fine stage capable of movement in six degrees of freedom.

2. Related Art

A typical lithography tool includes a radiation source, a projection optical system, and a substrate stage to support and move a substrate to be imaged. A radiation-sensitive material, such as resist, is coated onto the substrate surface prior to placement onto the substrate stage. During operation, radiation energy from the radiation source is used to project an image defined by an imaging element through the projection optical system onto the substrate. The projection optical system typically includes a number of lenses. The lens or optical element closest to the substrate is often referred to as the “last” or “final” optical element.

The projection area during an exposure is typically much smaller than the imaging surface of the substrate. The substrate therefore has to be moved relative to the projection optical system to pattern the entire surface. In the semiconductor industry, two types of lithography tools are commonly used. With so-called “step and repeat” tools, the entire image pattern is projected at once in a single exposure onto a target area of the substrate. After the exposure, the wafer is moved or “stepped” in the X and/or Y direction and a new target area is exposed. This step and repeat process is performed over and over until the entire substrate surface is exposed. With scanning type lithography tools, the target area is exposed in a continuous or “scanning” motion. The imaging element is moved in one direction while the substrate is moved in either the same or the opposite direction during exposure. The substrate is then moved in the X and/or Y direction to the next scan target area. This process is also repeated until all the desired areas on the substrate have all been exposed.

With both step and repeat and scanning type lithography tools, a substrate stage, commonly called a wafer stage, is used to both secure and position the substrate during exposure. The substrate is typically positioned on a fine stage, which is often positioned on a coarse stage. The coarse stage moves the fine stage and substrate in the X and/or Y directions in coarse increments during the step and repeat or scanning motion, while the fine stage moves the substrate in fine movements. Together, the coarse and fine stages work together to precisely position the correct portion of the substrate in the projection area. With scanning type tools, the imaging element is also moved by a stage, commonly called a reticle stage. In various known reticle stages, either a single stage (one stage holding one reticle), twin stage (two stages, each holding a single reticle), or double stage (one stage holding two reticles) have been considered. In one specific known example, a single reticle stage is used having three degrees of freedom (X, Y and θ_{z}). The issue with this type of stage is its movement is limited, and is unable to move in the vertical (Z, θₓ and θ_{y}) degrees of freedom. In the semiconductor industry, there is a constant drive to make the features on semiconductor devices smaller and smaller. To achieve the smaller features, lithography tools with larger and larger numerical apertures are needed. As the numerical aperture increases, the depth of focus becomes smaller, requiring more precise control of the imaging element in the vertical (Z, θₓ or θ_{y}) degrees of freedom. Since the aforementioned single stage does not have six degrees of freedom, its use in future lithography tools may be limited.

In another known design, the imaging element can be moved in six degrees of freedom by the combination of a fine stage supported by a coarse stage. Air pistons are used to support or suspend the fine stage over the coarse stage. At least six voice coil motors (VCMs) are used to move and position the fine stage in the six degrees of freedom. The magnets of all six VCMs are positioned on the fine stage, while the coils are all provided on the coarse stage. The VCM(s) used for moving the fine stage in the scanning direction need to be significantly large to make sure that the imaging element accelerates at the proper rate. In the future, as the throughput of lithography tools increases, the rate of acceleration of the fine stage containing the imaging element will also increase. Consequently the mass of the VCM(s) for accelerating the fine stage will become larger and larger. As the mass of the VCM increases, virtually everything else on the coarse stage will also need to increase in mass. The larger the mass, the more difficult it will become to accelerate the coarse stage. Consequently, the mass of this stage design has made it a limiting factor in increasing the rate of acceleration, and hence throughput, of future lithography tools.

A reticle or wafer stage with six degrees of freedom and a low mass coarse stage is therefore needed.

### SUMMARY

A reticle or wafer stage mover with six degrees of freedom, a low mass coarse stage, and the ability to move an object in a scanning direction in a lithography tool, is disclosed. The mover includes a coarse stage and a fine stage configured to support the object and supported by the coarse stage. A set of actuators is provided to move the fine stage in six degrees of freedom. All of the actuators contribute to accelerating the object and the fine stage in the scanning direction. With all the actuators generating the necessary force to move the fine stage, a single large actuator to push the fine stage in the scanning direction is eliminated. The size or mass of the coarse stage is therefore reduced. All of the actuators are also capable of generating a second force in either the X or Z directions. The actuators therefore also enable the fine stage and the object it supports to be positioned in six degrees of freedom, as well as moved in the scanning direction.

### BRIEF DESCRIPTION OF THE DRAWINGS

FIG. 1 is a diagram of a lithography tool using the object mover of the present invention.

FIGS. 2A-2E are diagrams of an object mover according to one embodiment of the present invention.

FIGS. 3A-3C are diagrams of an object mover according to another embodiment of the present invention.

FIGS. 4A-4B are diagrams of an object mover according to yet another embodiment of the present invention.

FIGS. 5A-5B are flow diagrams illustrating the sequence of fabricating semiconductor wafers according to the present invention.

Like reference numerals in the figures refer to like elements.

### DETAILED DESCRIPTION

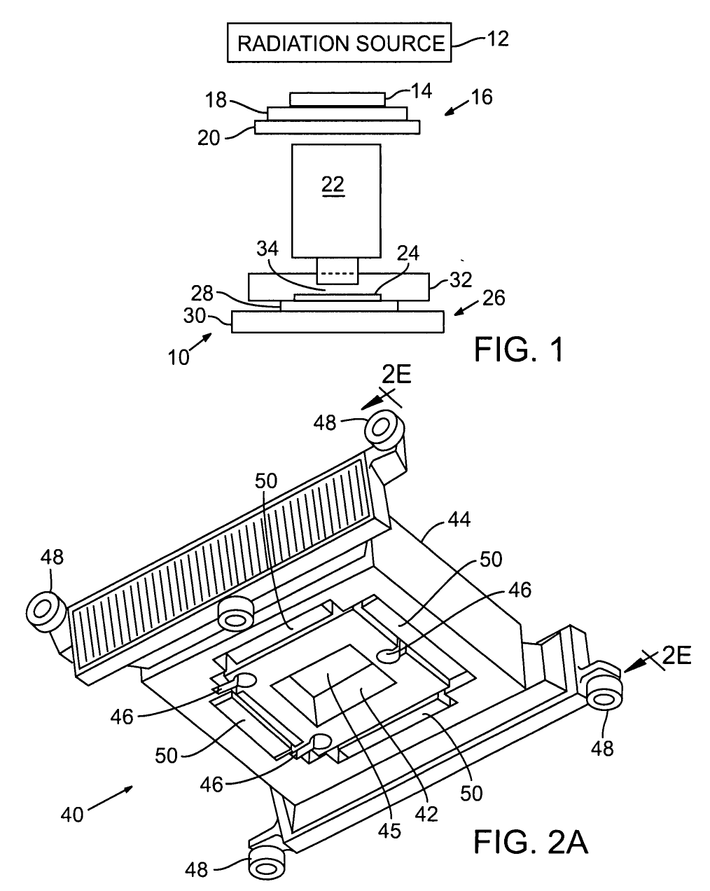

Referring to FIG. 1, a lithography tool or apparatus is shown. The apparatus 10 includes a radiation source 12, a patterning element 14, such as a reticle, which defines a pattern, a first mover 16 including a fine stage 18 and a coarse stage 20 to support and position the patterning element 14, and a projection optical system 22 to project radiation from the source 12 through the patterning element 14 onto a wafer 24 for the purpose of patterning the wafer as is well known in the lithography art. The wafer 24 is supported and positioned by a second mover 26 that includes a fine stage 28 and a coarse stage 30. In the embodiment shown, the apparatus 10 is an immersion type lithography tool. As such, the apparatus 10 further includes an immersion element 32, which maintains an immersion fluid (not illustrated) in the gap 34 between the last optical element 36 of the projection optical system 22 and the wafer 24. It should be noted that the embodiment shown is only exemplary. In no way is should the present invention be limited to immersion lithography. The present invention, as described in more detail below, can be used with both immersion and conventional or “dry” type lithography tools.

In the embodiment shown, the apparatus 10 is a scanning type tool, which means the first mover 16 moves the patterning element 14 and the second mover 26 supports and moves the wafer 24 during scanning operations, as discussed in the Background of the Invention. In alternative embodiments, the apparatus 10 is a step and repeat type tool. In which case, the first mover 16 can be eliminated and some other type of stationary holder can be used to support the patterning element 14, while the second mover 26 repeatedly steps the wafer during exposure.

The present invention is directed to a novel and useful design for a mover, which supports an object. The mover as described herein can be used to support and position either the patterning element 14 or a substrate upon which an image of the pattern is projected, such as either a semiconductor wafer or a flat panel substrate. Hence, the description of the mover as detailed below is generic in the sense that it can be used to support and position any “object” regardless if it is a patterning element 14, a wafer 24, or flat panel display. The present invention can therefore be used to implement the first mover 16, the second mover 26, or both in apparatus 10.

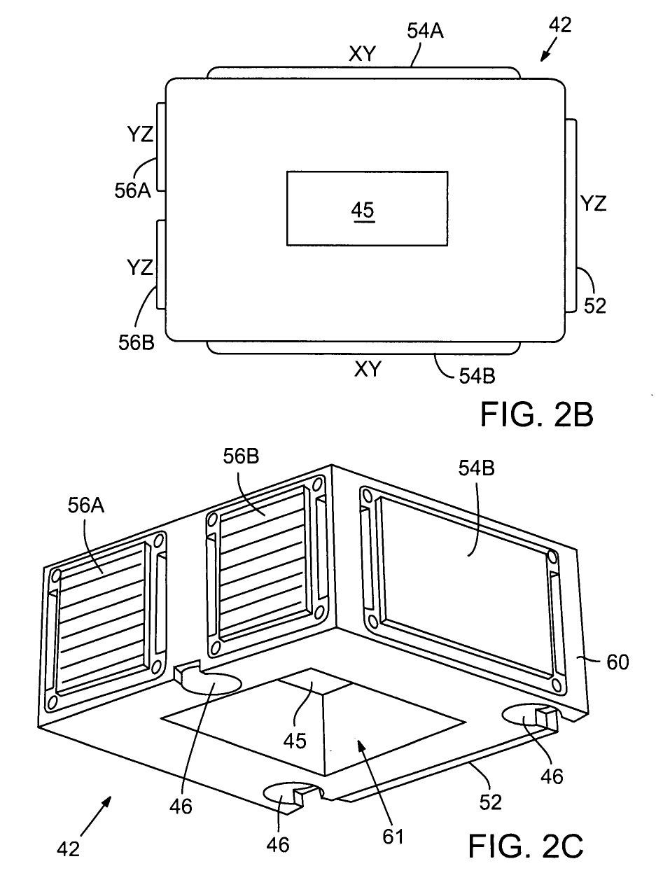

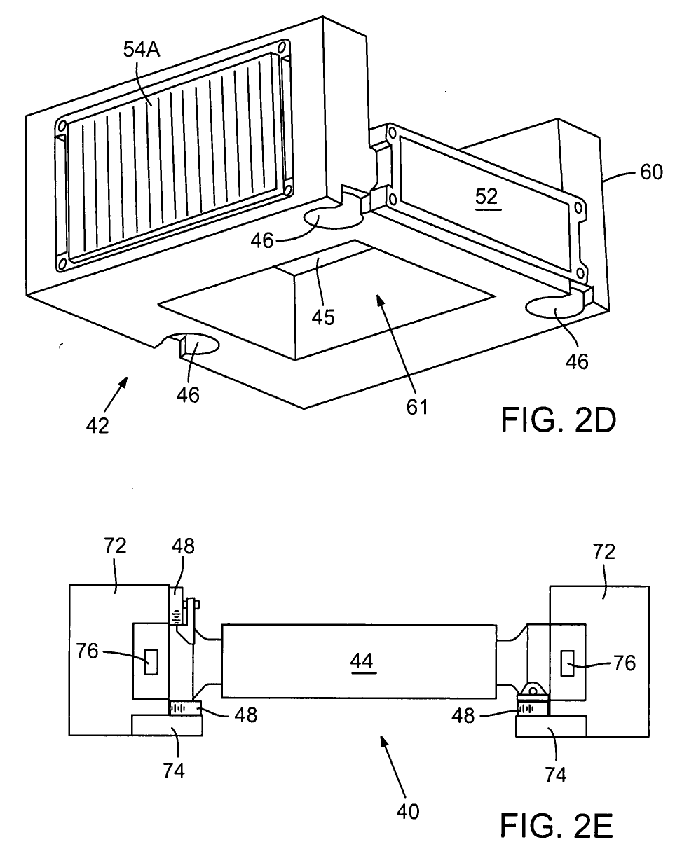

Referring to FIGS. 2A-2E, diagrams of an object mover, according to one embodiment of the present invention, is shown.

In FIG. 2A, a perspective view of the mover 40 is shown. The mover 40 includes a fine stage 42, which is nested in coarse stage 44. The fine stage 42 supports an object 45. A number of anti-gravity elements 46 are used to support the weight of the fine stage 42 in the Z or vertical direction. In various embodiments, the anti-gravity elements may be air pistons, bellows, or permanent magnets. The coarse stage 44 is a “picture frame” like structure that surrounds the fine stage 42. The coarse stage 44 is supported above a frame structure (not illustrated) by a plurality of air bearings 48.

The fine stage 42 is movable in six degrees of freedom (6DOF) by a set of actuators. All of the actuators are also used for accelerating the object 45 and the fine stage 42 in the scanning or Y direction. The actuators include a set of movers, typically a permanent magnet or an array of permanent magnets (hereafter generically referred to as “magnets”) located on the fine stage 42 and a set of corresponding stators 50 located on the coarse stage 44. As illustrated in the Figure, the stators 50 are provided on the four sides surrounding the fine stage 42. In one embodiment, the stators 50 on the coarse stage are arrays of electromagnetic coils. The magnets on the fine stage 42 are not visible in the figure, but are described in detail below with regard to other figures. With all the actuators generating the necessary force to move the fine stage in the scanning direction, the need for a single large actuator located, conventionally located on the coarse stage, can be eliminated. The size or mass of the coarse stage 44 of the present invention is therefore reduced relative to prior art movers. All of the actuators are also capable of generating a second force in either the X or Z directions. These actuators therefore enable the fine stage 42 and the object 45 it supports, to be positioned in six degrees of freedom, as well as moved in the scanning direction.

Details of the arrangement of the permanents magnets on the fine stage 42 are provided in FIGS. 2B-2D.

Referring to FIG. 2B, a top down view of the fine stage 42 illustrating the orientation of the permanent magnets is shown. The fine stage 42, which includes the object 45 supported thereon, includes a first magnet 52 generating forces in the Y and Z directions, second and third magnets 54A and 54B, both generating forces in the X and Y direction, and fourth and fifth magnets 56A and 56B both generating forces in the Y and Z directions.

Referring to FIG. 2C, a perspective view showing two sides of the fine stage 42 are shown. The fine stage 42 is a square or rectangular shaped frame 60 with a center recess region 61 for receiving and supporting the object 45. On the two visible sides of the fine stage 42 illustrated, magnets 56A and 56B are provided on the left side, whereas magnet 54B is provided on the right side.

Referring two FIG. 2D, a perspective view of the opposing two sides of the fine stage 42 are shown. Magnet 52 is provided on the left side and magnet 54A is provided on the right side of the fine stage when viewed from this angle.

As noted above, the coils 50 on the coarse stage 44 and the magnets 52, 54A, 54B, 56A and 56B provide a set of actuators. Each actuator is capable of generating (i) a force in the Y or scanning direction; and (ii) in either the X or Z direction as well. With this arrangement, a single large actuator, conventionally located on the coarse stage, can be eliminated. Furthermore, with the actuators each able to generate a force in another direction besides Y, the fine stage 42 and the object 45 it supports, can be moved in 6DOF.

Referring to FIG. 2E, a side view of the mover 40 from the line designated 2E in FIG. 2A is illustrated. The coarse stage 44 is provided between two counter-masses 72 located on opposing sides of the mover 40. The air bearings 48 are provided to support the mover 40 on a structural base 74. Motors 76, provided on opposing sides of the coarse stage 44, are provided to move the coarse stage 44, in the Y (i.e., scanning) direction. The counter-masses 72 are provided to absorb reaction forces when the motors 76 move the coarse stage 44. Additional motors, not visible in this cross section, may also be provided for moving the coarse stage in the X direction as well. In an alternative embodiment, the two counter-masses can optionally be joined together to form a single rigid body (not illustrated)

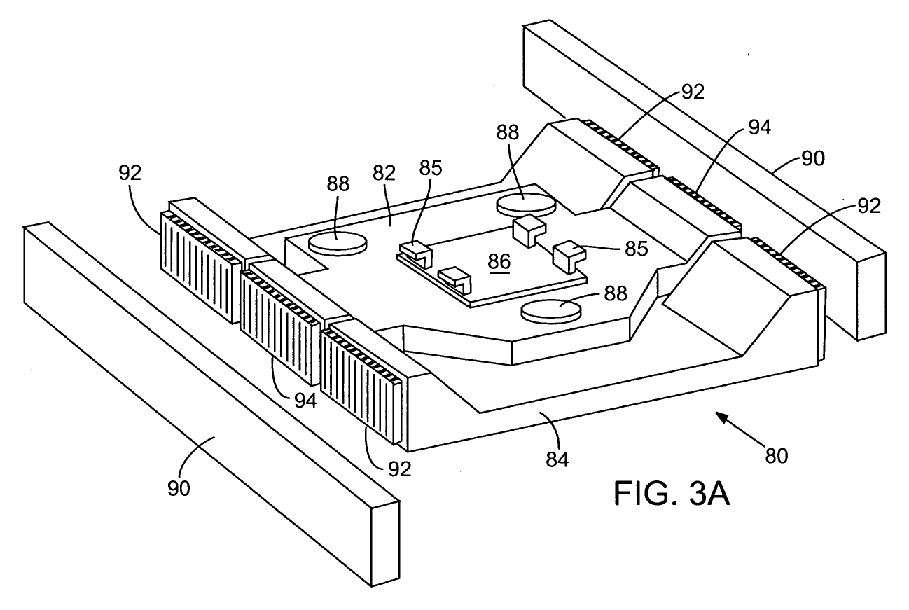

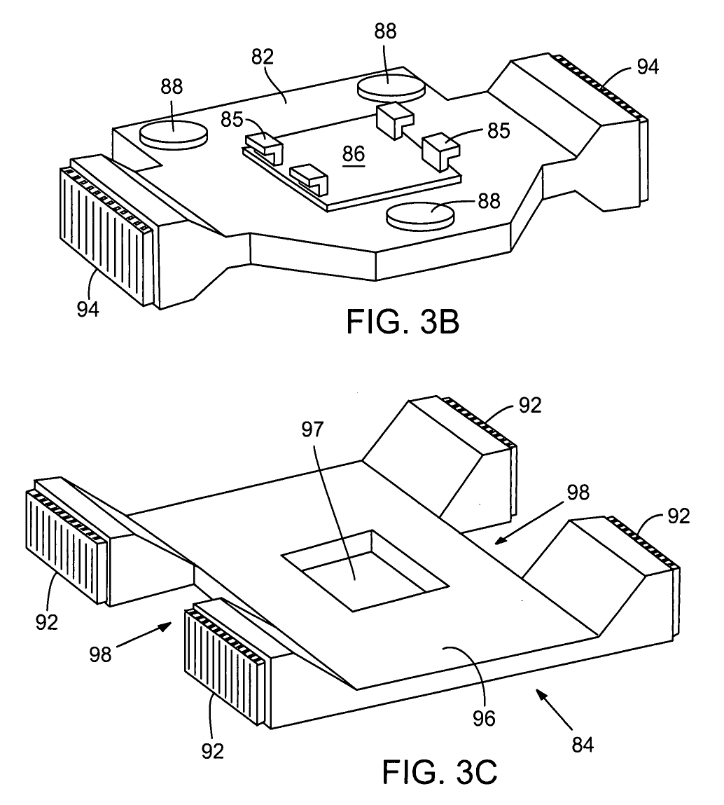

FIGS. 3A-3C are diagrams of an object mover according to another embodiment of the present invention. The mover 80 includes a fine stage 82 and a coarse stage 84 used to support an object 86. A plurality of anti-gravity devices 88 is provided on the fine stage 82 to support the fine stage in the vertical or Z direction. In various embodiments, the anti-gravity devices can be air pistons, bellows, or permanent magnets. The ant-gravity devices 88 may also include VCMs for positioning the fine stage 82 in the (Z, θₓ, and θ_{z}) directions. Clamps 85 on the fine stage 82 are provided to clamp the object 86 in place. Actuators, including coil arrays 90 and magnets 92 (e.g., a single magnet or an array of magnets) on the coarse stage 84 and magnets 94 on the fine stage 82, are provided to move both the fine stage 42 and coarse stage 44 in the X, Y and θ_{z} directions. The magnets 92 and 94 on the each side of the coarse and fine stages are arranged in a linear fashion with respect to one another and adjacent the shared coil arrays 90 respectively. With this arrangement, the fine stage 82 and the coarse stage 84 share the same coil arrays, but are driven independently.

Referring to FIG. 3B, a perspective view of just the fine stage 82 is shown. In this figure, the object 86 is shown on the stage 82 along with the anti-gravity elements 88. The magnets 94 are provided on opposing sides of the fine stage 82.

Referring to FIG. 3C, a perspective view of just the coarse stage 84 is shown. The coarse stage includes a platform 96 upon which the fine stage 82 is positioned. Two recess regions 98, on opposing sides of the coarse stage 84, are provided to accommodate the magnets 94 of the fine stage. With this arrangement, the X and Y actuators for the fine stage 42 are not on the coarse stage 44, so the coarse stage can be made smaller and lighter. In embodiments where the mover 80 is a reticle stage, a recess 97 is provided in the coarse stage to allow light to pass through the reticle and the coarse stage.

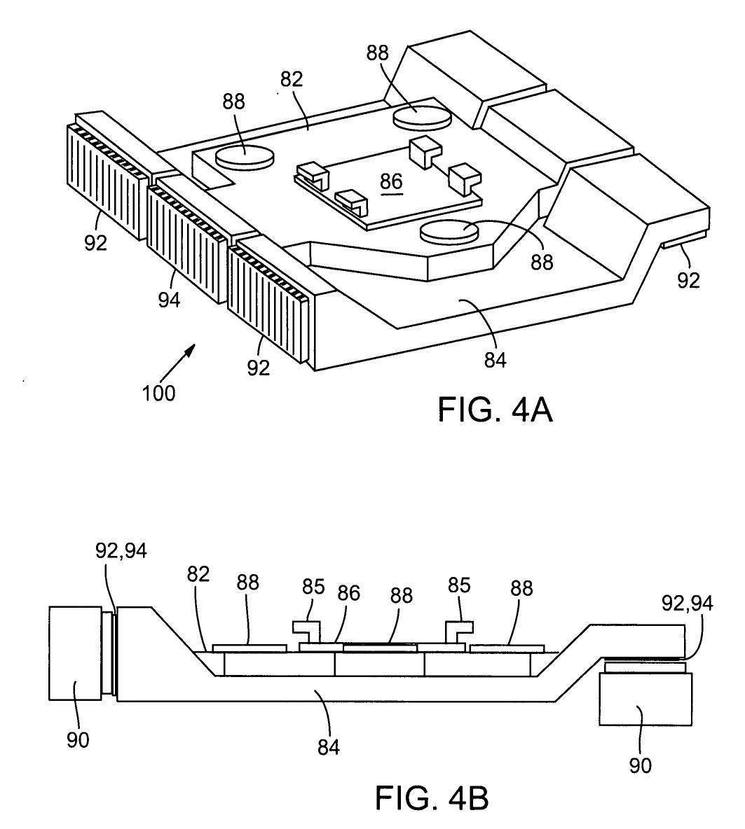

Referring to FIGS. 4A and 4B, diagrams of an object mover 100 according to yet another embodiment of the present invention. Mover 100 is essentially the same as mover 80 described above, with the exception of the magnets 92 and 94 on both the coarse stage 84 and the fine stage 82 on one side of the mover 100 are oriented in the horizontal plane, as opposed to the vertical plane. This arrangement is best illustrated in FIG. 4B, which shows the magnets 92, 94 and coil array 90 of the left most actuator oriented in the vertical plane, whereas the magnets 92, 94 and the coil array 90 of the right most actuator are oriented in the horizontal plane. The advantage of the horizontal orientation is that it creates clearance for other equipment in the lithography apparatus, such as the interferometer beams of an interferometer.

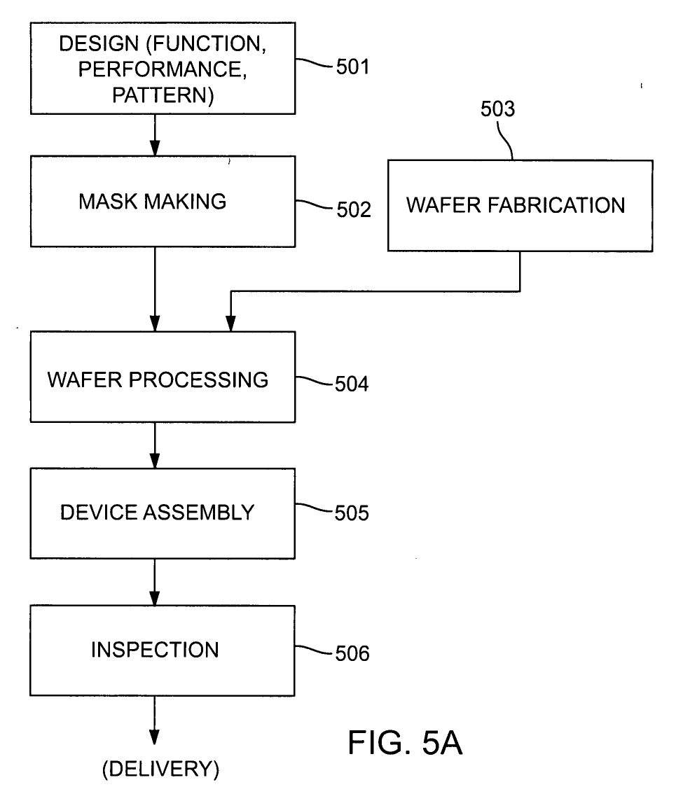

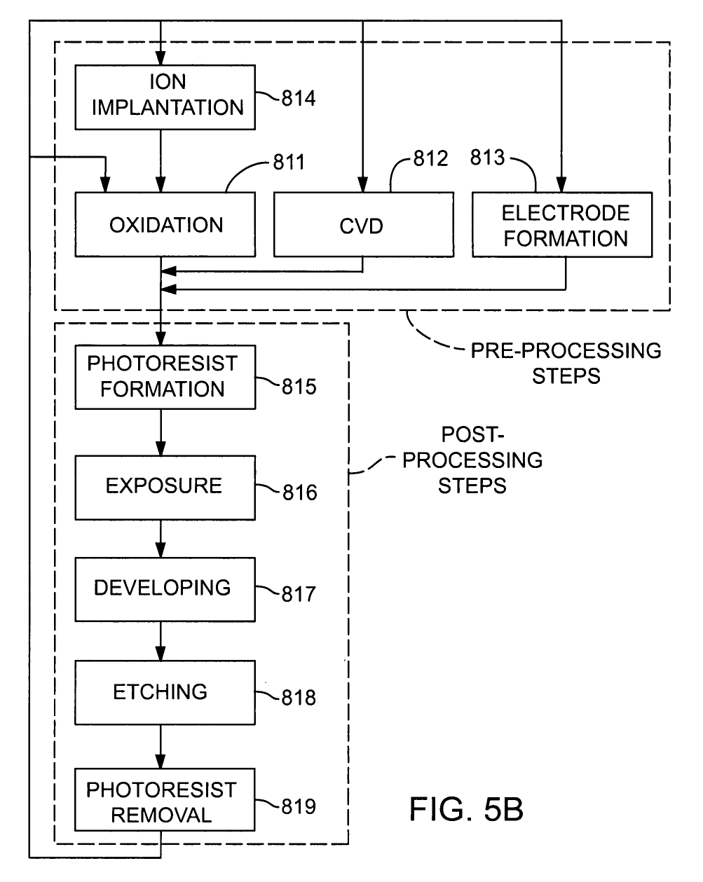

Semiconductor devices can be fabricated using the above described systems, by the process shown generally in FIG. 5A. In step 501 the device's function and performance characteristics are designed. Next, in step 502, a mask (reticle) having a pattern is designed according to the previous designing step, and in a parallel step 503 a wafer is made from a silicon material. The mask pattern designed in step 502 is exposed onto the wafer from step 503 in step 504 by a photolithography system described hereinabove in accordance with the present invention. In step 505 the semiconductor device is assembled (including the dicing process, bonding process and packaging process), finally, the device is then inspected in step 506.

FIG. 5B illustrates a detailed flowchart example of the above-mentioned step 504 in the case of fabricating semiconductor devices. In FIG. 5B, in step 511 (oxidation step), the wafer surface is oxidized. In step 512 (CVD step), an insulation film is formed on the wafer surface. In step 513 (electrode formation step), electrodes are formed on the wafer by vapor deposition. In step 514 (ion implantation step), ions are implanted in the wafer. The above-mentioned steps 511-514 form the preprocessing steps for wafers during wafer processing, and selection is made at each step according to processing requirements.

It should be noted that the particular embodiments described herein are merely illustrative and should not be construed as limiting. For example, the substrate described herein does not necessarily have to be a semiconductor wafer. It could also be a flat panel used for making flat panel displays. Rather, the true scope of the invention is determined by the scope of the accompanying claims.

1. An apparatus, comprising:
a mover configured to support and move an object in a scanning direction in a lithography tool, the mover including:
a coarse stage; and
a fine stage configured to support the object and supported by the coarse stage, the fine stage movable in six degrees of freedom by a set of actuators,
wherein, all of the actuators contribute to accelerating the object and the fine stage in the scanning direction.

2. The apparatus of claim 1, wherein a first subset of the set of actuators is configured to generate forces to move the fine stage in the scanning direction and the vertical direction.

3. The apparatus if claim 2, wherein there are at least three actuators in the first subset of actuators.

4. The apparatus of claim 1, further comprising a second subset of the set of actuators, the second subset of actuators configured to generate forces in the scanning direction and in a direction perpendicular to the scanning direction.

5. The apparatus of claim 4, where in the second subset of actuators consists of one of the following:
(i) at least one actuator;
(ii) two actuators; or
(iii) two or more actuators.

6. The apparatus of claim 1, wherein the set of actuators comprises a set of stators.

7. The apparatus of claim 6, wherein the set of stators are located on the coarse stage.

8. The apparatus of claim 1, wherein the fine stage is surrounded by the coarse stage.

9. The apparatus of claim 1, further comprising one or more counter-mass elements positioned adjacent the coarse stage to absorb reaction forces generated by moving the coarse and/or fine stage.

10. The apparatus of claim 1, further comprising one or more reaction frame elements positioned adjacent the coarse stage to absorb reaction forces generated by moving the coarse and/or fine stage.

11. The apparatus of claim 1, further comprising a second set of actuators, wherein one or more of the second set of actuators is configured to generate a force configured to move the coarse stage in the scanning direction.

12. The apparatus of claim 11, wherein one or more of the second set of actuators is configured to generate a force configured to move the coarse stage perpendicular to the scanning direction.

13. The apparatus of claim 11, wherein one or more of the second set of actuators is configured to generate a force configured to rotate the coarse stage about a vertical axis.

14. The apparatus of claim 1, wherein the fine stage is configured to support and position a second object.

15. The apparatus of claim 1, further comprising:
a second fine stage configured to support a second object, the second fine stage movable in six degrees of freedom by a second set of actuators,
wherein all of the actuators of the second set contribute to accelerating the second object and the second fine stage in the scanning direction.

16. The apparatus of claim 15, wherein the second fine stage is supported by the coarse stage.

17. The apparatus of claim 15, further comprising a second coarse stage, wherein the second fine stage is supported by the second coarse stage.

18. The apparatus of claim 1, wherein the set of actuators comprise a set of permanent magnets located on fine stage and set of stators located on the coarse stage, wherein the set of permanent magnets and the set of stators cooperate together to move the fine stage in six degrees of freedom.

19. The apparatus of claim 18, wherein the set of stators comprise a set of coils.

20. The apparatus of claim 1, wherein the object is a semiconductor wafer and the mover is a wafer stage in a lithography tool.

21. The apparatus of claim 1, wherein the object is a reticle and the mover is a reticle stage in a lithography tool.

22. The apparatus of claim 1, further comprising:
a patterning element which defines a pattern;
a radiation source;
a projection optical system to project radiation from the radiation source through the patterning element to project the pattern onto the object supported by the mover.

23. The apparatus of claim 1, wherein the object is a reticle, which defines a pattern, wherein the mover is configured to move the reticle.

24. The apparatus of claim 23, further comprising:
a radiation source;
a projection optical system configured to project radiation from the radiation source through the reticle to project the pattern onto a second object supported by a second mover.

25. The apparatus of claim 24, wherein the apparatus is a lithography tool.

26. The apparatus of claim 25, wherein the lithography tool is an immersion lithography tool.

27. An apparatus comprising:
a mover configured to support and move an object in a scanning direction in a lithography tool, the mover including:
a coarse stage having one or more coarse stage actuators, the coarse stage actuators comprising one or more coarse stage movers; and
a fine stage configured to support the object and supported by the coarse stage, the fine stage further including one or more fine stage actuators including one or more fine stage actuators,
wherein the one or more coarse stage movers and the one or more fine stage movers share one or more stators respectively.

28. The apparatus of claim 27, wherein each of the one or more coarse stage movers is either a permanent magnet or a permanent magnet array.

29. The apparatus of claim 27, wherein each of the one or more fine stage movers is either a permanent magnet or a permanent magnet array.

30. The apparatus of claim 27, wherein each of the shared stators is a coil array.

31. The apparatus of claim 27, wherein a first of the actuators is oriented in a vertical plane with respect to the fine and the coarse stages and a second of the actuators is oriented in a horizontal plane with respect to the fine and the coarse stages.

32. The apparatus of claim 27, wherein the one or more coarse stage actuators and the one or more fine stage actuators move both the coarse stage and the fine stage in the X, Y and O directions respectively.

33. The apparatus of claim 27, wherein the fine stage further comprises one or more VCMs for positioning the fine stage in the Z, θₓ, and θ_{z}) directions.

34. The apparatus of claim 27, wherein the mover is either a reticle stage or a wafer stage in a lithography tool.
